(19) United States
(12) Patent Application Publication
(10) Pub. No.: US 2026/0254694 A1
(43) Pub. Date: Aug. 27, 2026

(54) METHOD FOR BOOSTING UPLINK PHASE TRACKING REFERENCE SIGNAL DURING SPATIAL DOMAIN FALLBACK OPERATION

(71) Applicant: Google LLC, MOUNTAIN VIEW, CA (US)

(72) Inventors: Yushu ZHANG, Beijing (CN); Jia-Hong LIOU, Taipei (TW)

(21) Appl. No.: 19/163,331

(22) PCT Filed: Mar. 31, 2023
(86) PCT No.: PCT/CN2023/085392

§ 371 Date: Sep. 8, 2025

(51) Int. Cl. H04L 27/26; H04W 52/32; H04W 72/21

(52) U.S. Cl. CPC H04L 27/261; H04W 52/325; H04W 72/21

(57) ABSTRACT

Methods and devices in a wireless network enable transmitting boosted phase tracking reference signals when using a subset of antenna ports. The network directs a user equipment to boost the power level of one or more antenna ports usable to transmit the phase tracking reference signals, and/or to use a precoder corresponding to a subset-codebook-coherency different yet compatible with a coherency type supported by user equipment's full set of antenna ports.

### FIELD OF THE DISCLOSURE

This document generally describes methods and devices operating in wireless communication systems such as (but not limited to) the ones described in 5G standard documents, known as 3GPP communication systems.

### BACKGROUND

A 5G user equipment (UE) described in current standard documents is configurable to transmit a phase tracking reference signal (PT-RS) associated with a physical uplink shared channel (PUSCH) to enable phase tracking and compensation of received PUSCH data. A network entity, NE, configures a number of UE antenna ports for a PUSCH transmission by configuring the number of ports for Sounding Reference Signals, SRS. In a spatial domain fallback operation, the NE configures the UE to transmit using a subset of antenna ports (or a subset with fewer UE's antenna ports than currently used) in view of the uplink channel state information (CSI) measurement or UE assist information on UE's preferred number of antenna ports for UE power saving. When configuring the UE to transmit PT-RS as part of an uplink codebook-based transmission, the NE specifies or otherwise directs UE relative to which antenna ports to be used for transmitting the PT-RS, and a codebook coherency type. Standard documents (e.g., section 6.1.1.1 of 3GPP TS 38.214 and section 6.2.3 of 3GPP TS 38.214) describe procedures for uplink codebook-based transmission and for PT-RS transmission.

In order to enable the NE to configure codebook-based uplink transmission, the UE reports UE-compatible configuration parameters to the NE. Such UE-compatible configuration parameters are a maximum number of SRS ports and a supported codebook coherency type (e.g., “non-coherent”, “partial and non-coherent”, “full and partial and non-coherent”). For a full coherent codebook-based transmission, the UE uses a precoder with at least one column with all non-zero coefficients

$$( e . g . , {\frac{1}{2 \sqrt{2}} [ 1 , 1 , 1 , 1 , 1 , 1 , 1 , 1 ]}^{T} ) .$$

For a partial coherent codebook-based transmission, the UE uses a precoder in which each column includes a subset of non-zero coefficients

$$( e . g . , {\frac{1}{2 \sqrt{2}} [ 1 , 0 , 1 , 0 , 1 , 0 , 1 , 0 ]}^{T} or {\frac{1}{2 \sqrt{2}} [ 1 , 0 , 0 , 0 , 1 , 0 , 0 , 0 ]}^{T} ) .$$

For a non-coherent codebook-based transmission, the UE uses a precoder with only one non-zero coefficient in each column

$$( e . g . , {\frac{1}{2 \sqrt{2}} [ 1 , 0 , 0 , 0 , 0 , 0 , 0 , 0 ]}^{T} ) .$$

Antenna ports corresponding to non-zero coefficients transmit with the same phase.

If a UE has reported “partial and non-coherent” codebook coherency type, the NE can configure the UE using a subset of antenna ports only for a partial coherent codebook-based transmission or a non-coherent codebook-based transmission, but not for a full coherent codebook-based transmission. However, the UE using a subset of antenna ports may be able to favorably transmit the PT-RS using the full coherent codebook-based transmission yielding a stronger PT-RS than the partial coherent and non-coherent transmissions.

Additionally, during a fallback operation, the conventional UE is limited to using a conventionally allocated power level for transmitting the PT-RS, not taking advantage of available power to increase it.

### SUMMARY

Methods performed by UE and NE embody techniques for UE transmitting a boosted PT-RS enabling a better reception thereof by the NE, and, therefore, a more accurate phase compensation improving PUSCH data processing. The UE may increase the transmission power for the PT-RS antenna port(s) above the conventional allocated power. Alternatively or additionally, the UE may include PT-RS in a subset codebook-based transmission corresponding to a subset-codebook-coherency type that is different yet compatible with the UE's codebook coherency type. The NE and UE maintain the same understanding on the UE capability of codebook coherency when the NE configures the UE to use a subset of antenna ports. Accordingly, a UE that reports partial and non-coherent codebook coherency type can be configured to transmit PT-RS generated using full-coherent based precoders when using a subset of antenna ports.

### BRIEF DESCRIPTION OF THE DRAWINGS

The accompanying drawings, which are incorporated in and constitute a part of the specification, illustrate one or more embodiments and, together with the description, explain these embodiments.

FIG. 1 illustrates an operating environment in which embodiments can be employed.

FIG. 2 is a diagram of wireless system with devices implementing PT-RS boosting according to various embodiments.

FIG. 3 is a signaling diagram of a PT-RS boosting technique during uplink spatial domain fallback operation according to an embodiment.

FIG. 4 is a flowchart depicting UE's behavior for PT-RS boosting during uplink spatial domain fallback operation according to an embodiment.

FIG. 5 is a flowchart illustrating NE's behavior for PT-RS boosting during uplink spatial domain fallback operation according to an embodiment.

FIGS. 6A, 6B and 6C illustrate an EPRE ratio determination based on the number of layers corresponding to a non-zero-power antenna port according to an embodiment.

FIGS. 7A, 7B and 7C illustrate PT-RS power borrowing according to an embodiment.

FIGS. 8A and 8B are graphs illustrating an EPRE ratio determination based on the number of layers according to an embodiment.

FIG. 9 is a flowchart of a method performed by a UE according to an embodiment.

FIG. 10 is a flowchart of a method performed by a NE according to an embodiment.

### DETAILED DESCRIPTION

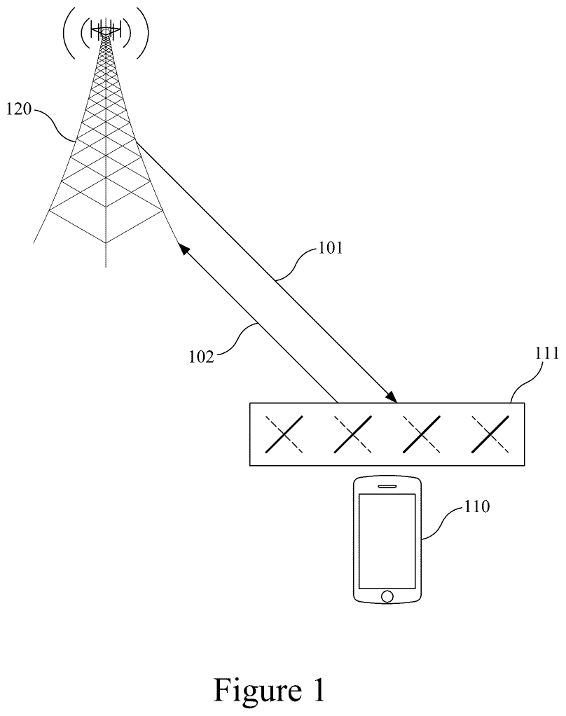

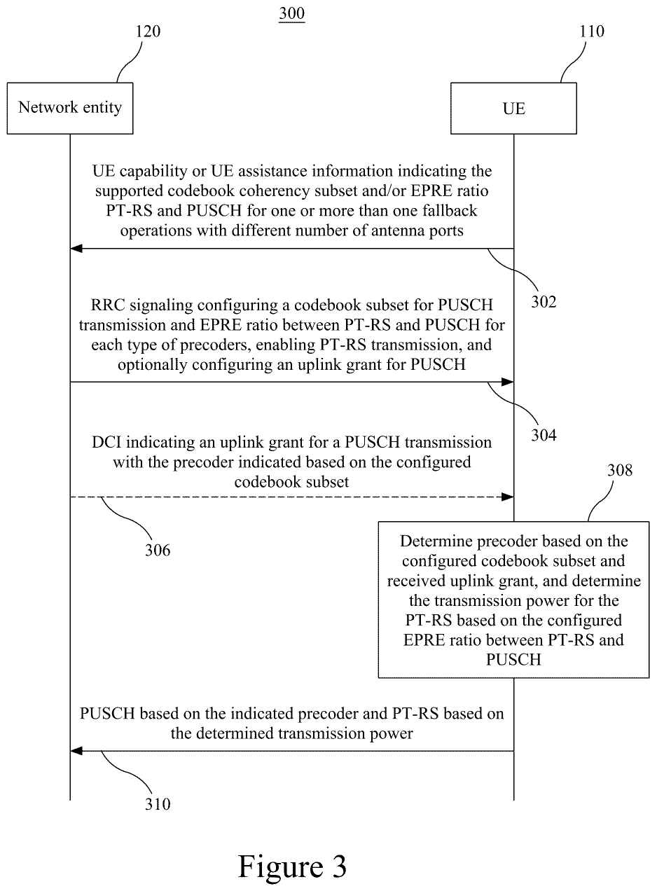

FIG. 1 illustrates an operating environment for embodiments described hereinafter. UE 110 receives control signaling 101 (e.g., radio resource control, RRC, signaling and, possibly, also downlink control information, DCI, signaling as discussed in more detailed relative to FIG. 3) from NE 120. Control signaling 101 includes parameters configuring UE 110 for an uplink transmission 102 including a PT-RS and employing a subset of UE's antenna 111. In FIG. 1, continuous lines represent enabled antenna ports (i.e., antenna ports included in the subset) and dashed lines represent disabled antenna ports (i.e., antenna ports not included in the subset). Thus, during a fallback operation, UE 110 has four antenna ports enabled and four antenna ports disabled (a configuration that is an example of antenna port subset and not a limitation).

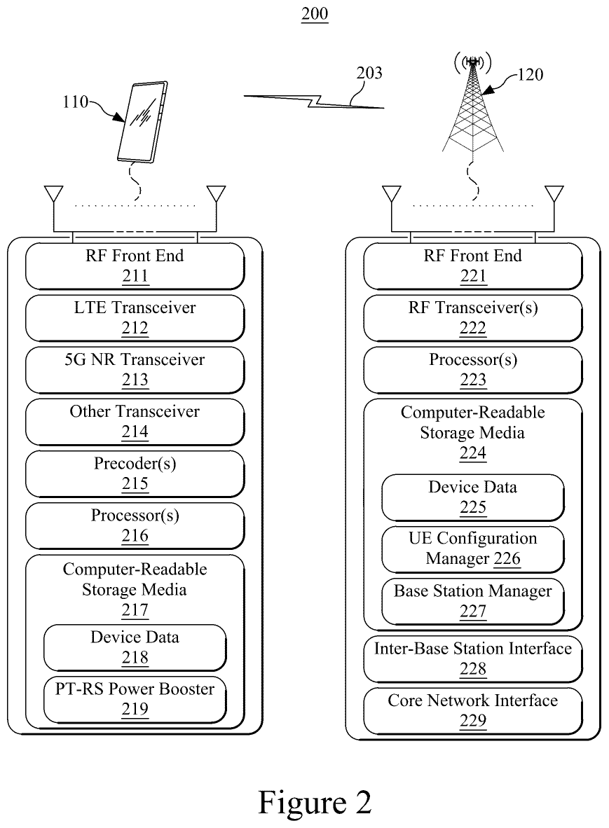

FIG. 2 depicts a wireless communication system 200 including UE 110 and NE 120 that can implement various aspects of a subset codebook-based transmission according to embodiments. UE 110 and NE 120 may include additional functions and interfaces omitted from FIG. 2 in the interest of brevity. Signaling arrow 203 generally represents both uplink and downlink signals (such as, 101 and 102 in FIG. 1) transmitted by UE 110 and NE 120. respectively.

UE 110 includes antennas connected to a radio frequency (RF) front end 211, and at least one RF transceiver (such as, an LTE transceiver 212, a 5G NR transceiver 213, or a 6G transceiver 214) for communicating with NE 120. The antennas and the RF front end 211 can be tuned to one or more frequency bands, as may be defined by 3GPP LTE, 5G NR, and 6G communication standards and implemented by LTE transceiver 212, 5G NR transceiver 213, and/or the 6G transceiver 214. UE 110 also includes one or more precoders 215, one or more processor(s) 216, and computer-readable storage media (CRM) 217. Each of the one or more precoders 215 corresponds to a specific coherency type. Processor(s) 216 may be single or multiple-core processors, and CRM 217 includes any suitable memory/storage other than propagating signals. For example, memory/storage can include random-access memory (RAM), static RAM (SRAM), dynamic RAM (DRAM), non-volatile RAM (NVRAM), read-only memory (ROM), and/or flash memory useable to store device data 218 and PT-RS booster 219 implementing various methods for boosting power of uplink PT-RS during UE's 110 spatial domain fallback operation. Device data 218 stores instructions executable by processor(s) 216 to facilitate user-plane communication, control-plane signaling (i.e., wireless communication 203 with NE 120) and user interaction for UE 110. PT-RS booster 219, which may be implemented not only as software but also as hardware logic and/or circuitry, causes various steps and actions associated with boosting PT-RS (i.e., increasing power level and/or using a precoder that yields a better PT-RS signal) during fallback operation as described herein.

NE 120 is illustrated in FIG. 2 provides functionality of a gNB (5G or 6G base station) or an eNB (LTE base station). However, NE 120's functionality may be distributed across multiple entities (e.g., a central unit, CU, a distributed unit, DU, and a radio unit, RU). NE 120 includes antennas and an RF front end 221 and RF transceiver(s) 222 (may be more transceivers for different technologies, as illustrated for UE 110) for communicating with UE 110 and other NEs. NE's antennas and RF front end 221 can be tuned to one or more frequency bands, e.g., as may be defined by 3GPP LTE, 5G NR, and 6G communication standards and implemented by RF transceiver(s) 222.

NE 120 includes processor(s) 223 and computer-readable storage media (CRM) 224. Processor(s) 223 can include single or multiple-core processors, and CRM 224 includes any suitable memory/storage except propagating signals. For example, memory/storage can include random-access memory (RAM), static RAM (SRAM), dynamic RAM (DRAM), non-volatile RAM (NVRAM), read-only memory (ROM), and/or flash memory. CRM 224 stores device data 225, that includes network scheduling data, radio resource management data, applications, and/or an operating system, which are executable by processor(s) 223 to enable wireless communication 203 with UE 110.

CRM 224 also stores UE configuration manager 226 and a base station manager 227. UE configuration manager 370 causes NE to perform various steps and actions associated with configuring the UE to boost PT-RS, and with processing received PT-RS as described herein. Base station manager 227 configures antenna and RF transceiver(s) 222 for communication with the UE 110, and other network nodes (e.g., a Radio Access Network, RAN, controller and a RAN Intelligent Controller, RIC), and/or communication with the core network (e.g., an EPC or a 5GC core network).

NE 120 also includes inter-base station interface 228 and core-network interface 229. Inter-base station interface 228 can be a standardized interface, such as an Xn and/or X2 interface, which base station manager 227 may configure to exchange user-plane and control-plane data with another NE (e.g., in case of a handover). Core-network interface 229 can be configured by base station manager 227 to exchange user-plane data and control-plane information with core network functions and/or entities.

A wireless system as the one schematically illustrated in FIG. 2 performs techniques for boosting PT-RS during fallback operation according to various embodiments, in an operating environment as illustrated in FIG. 1. FIG. 3 is a signaling diagram (with time flowing from top to bottom) of such a PT-RS boosting technique for uplink spatial domain fallback operation according to an embodiment. UE 110 reports 302 UE's capability or UE assistance information via an RRC message to indicate UE supported codebook coherency for one or more than one spatial domain fallback operations (e.g., different spatial domain fallback operations use subsets of antenna ports including different number of antenna ports for PUSCH codebook-based transmission). Alternatively or additionally, UE 110 also reports a supported energy per resource element (EPRE) ratio between PT-RS and PUSCH for the one or more than one fallback operations. Although this signal diagram shows direct reporting from UE 110 to the NE 120, other possibilities are not excluded. For example, the UE may report to a base station and then be handover to the NE; the base station would then transfer the report content to the NE. In another example, the UE may report to the core network when registered and the core network would provide the report to the NE preparing control signal to configure the UE for a fallback operation.

NE 120 then transmits 304 RRC signaling for configuring a subset codebook-based PUSCH transmission and a number of SRS antenna ports in the subset. The RRC signaling may also indicate an EPRE ratio between PT-RS and PUSCH for each type of precoders (i.e., coherency type). The RRC signaling may be a RRC reconfiguration message from NE 120 to UE 110, or a system information block (SIB), where the SIB can be an existing SIB (e.g., SIB1) or a new SIB (e.g., SIB J, where J is an integer above 21) transmitted by the NE.

If NE 120 configures the PUSCH transmission for a cyclic prefix orthogonal frequency division multiplexing (CP-OFDM) waveform, it disables the transform precoding. For a configured-grant PUSCH transmission, the NE configures an uplink grant for the PUSCH by the RRC signaling. For dynamic-grant PUSCH or Type2 configured-grant PUSCH, the NE transmits 306 Downlink Control Information (DCI) indicating an uplink grant for the PUSCH transmission, where the NE indicates associated DMRS port(s) for PT-RS port(s). The UE transmits the PT-RS port based on the same precoder as the one applied for the associated DMRS port. The NE transmitting DCI is, thus, an option such a transmission not being not necessary in all situations (being optional is suggested by the dashed-line rectangle). Based on the received RRC signaling and/or DCI, UE 110 determines 308 the precoder and/or the transmission power for PT-RS. Then, UE 110 transmits 310 the PT-RS and PUSCH data using the determined precoder and/or transmission power.

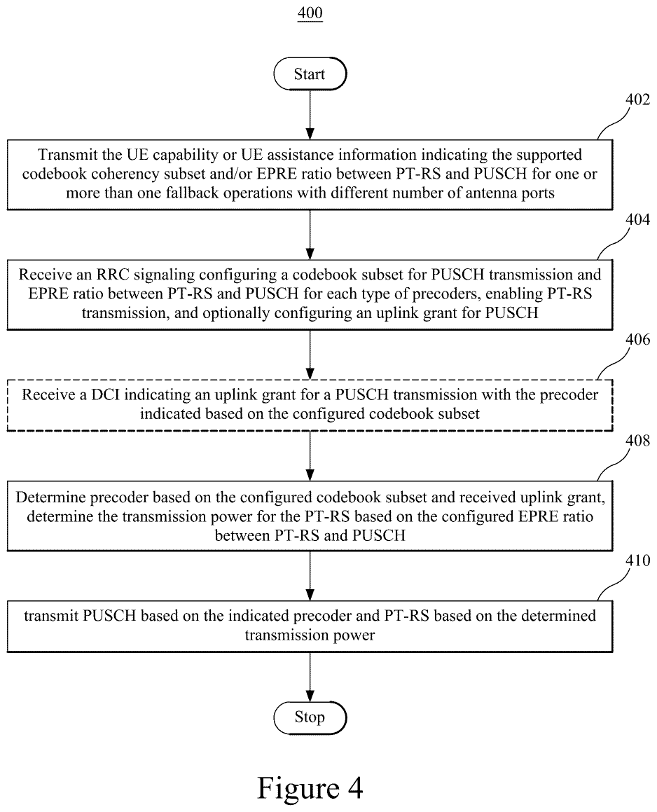

FIG. 4 is a flowchart illustrating UE's behavior (e.g., UE 110) for PT-RS boosting during uplink spatial domain fallback operation according to an embodiment.

The UE transmits 402 a message (e.g., an RRC message) reporting UE's capability or UE assistance information to indicate UE supported codebook coherency for one or more than one spatial domain fallback operations. The UE then receives 404 an RRC signaling for configuring a subset codebook PUSCH transmission and a number of SRS antenna ports in the subset. This message may also include an uplink grant for the PUSCH transmission. As mentioned above, the RRC signaling may be a RRC reconfiguration message or an SIB.

Optionally, (as suggested by the dashed-line rectangle in FIG. 4), the UE may also receive 406 DCI indicating an uplink grant for the PUSCH transmission, where the NE indicates associated DMRS port(s) for PT-RS port(s). Based on the received RRC signaling and/or DCI, the UE determines 408 the precoder and/or the transmission power for PT-RS and then transmits 410 the PT-RS and PUSCH data using the determined precoder and/or transmission power.

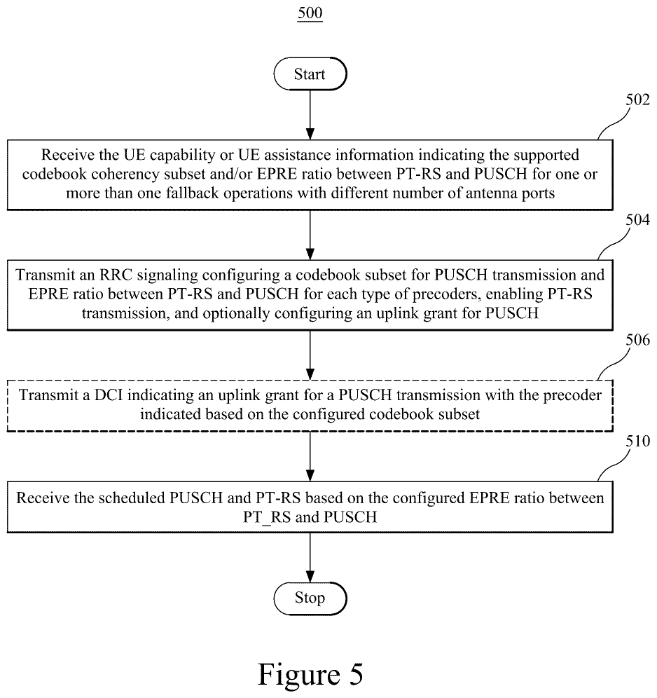

FIG. 5 is a flowchart illustrating NE's behavior (e.g., NE 120) for PT-RS boosting during uplink spatial domain fallback operation. The NE receives 502 a message (e.g., an RRC message) reporting UE's capability or UE assistance information to indicate UE supported codebook coherency for one or more than one spatial domain fallback operations. The NE then transmits 504 an RRC signaling for configuring a subset codebook PUSCH transmission and a number of SRS antenna ports in the subset. This message may also include an uplink grant for the PUSCH transmission. The RRC signaling may be a RRC reconfiguration message or an SIB.

Optionally, (as suggested by the dashed-line rectangle in FIG. 5), the NE may also transmit 506 DCI indicating an uplink grant for the PUSCH transmission, where the NE indicates associated DMRS port(s) for PT-RS port(s). Finally, NE receives 410 the PT-RS and PUSCH data.

Relative to codebook coherency capability report and configuration, in an embodiment, a UE with 8 or more transmission ports (i.e., a UE able to transmit SRS from 8 or more than 8 ports), may indicate as a part of the UE capability indicating whether it supports N-port partial-coherency, where N is an integer above 1, and may be determined based on the number of transmission ports (e.g., N=2 or 4 for 8 ports transmission ports). The N-port partial-coherency precoder indicates a precoder with up to N non-zero coefficients for each layer (column of the precoder). The NE may configure an uplink codebook transmission using a subset of N UE's antenna ports as an N-port full coherent transmission, an N-port partial-coherent transmission and/or an N-port non-coherent transmission via RRC signaling. The UE may determine the precoder for the PUSCH transmission based on the indicated transmission precoder matrix indicator (TPMI), transmission rank indicator (TRI) and the subset-codebook-coherency type. The precoder is the one indicated by the TPMI and TRI from the configured codebook subset.

For example, an 8-port codebook may comprise 4 types of precoders: full coherent precoders, 4-port partial-coherent precoders, 2-port partial-coherent precoders, and non-coherent precoders. A UE may report the supported types of precoders in the UE capability, and the NE may select the subset-codebook-coherency type based on one or more supported types of precoders.

In some implementations, when a UE is configured to transmit with a subset of UE's transmission ports, the NE and the UE determine the subset-codebook-coherency type based on the UE supported codebook coherency types reported via the UE capability and corresponding to all (i.e., the maximum number of) UE's transmission ports. For example, if the UE reports that it supports full and partial and non-coherent precoders, the UE still supports such type of precoders when configured with a smaller subset number of ports. If the UE reports that it supports N-port partial coherent and non-coherent precoders, the UE supports full coherent transmission when configured with less than N ports in the subset. If the UE reports that it supports N-port partial coherent and non-coherent precoders, the UE supports N-port or less than N-port partial coherent transmission when configured with a number of ports above N. If the UE reports that it only supports non-coherent precoders, it can only support non-coherent precoders when configured to use a smaller number of ports. Table 1 illustrates an example of determining for the UE capability for an 8-port UE configured with a 2-port or 4-port based uplink transmission.

TABLE 1

| | UE capability when | UE capability when |
|---|---|---|
| | configured for 4-port | configured for 2-port |
| Reported UE capability | transmission | transmission |
| Full/partial/non-coherent | Full/partial/non-coherent | Full/non-coherent |
| 4-port partial-coherent/ | Full/partial/non-coherent | Full/non-coherent |
| 2-port partial-coherent/ | | |
| non-coherent | | |
| 2-port partial-coherent/ | Partial-coherent/non- | Full/non-coherent |
| non-coherent | coherent | |
| Non-coherent | Non-coherent | Non-coherent |

In some other embodiments, the UE reports the UE capability indicating supported codebook coherency types for all the candidate number of transmission ports. In one example, for an 8-port UE, it may report the supported codebook coherency types when configured for 2-port, 4-port and 8-port transmission respectively. Further, the UE may also report some other UE capabilities related to uplink transmission corresponding to each number of configured ports, including at least one of: UE's maximum number of uplink PT-RS ports (e.g., whether the UE supports 2 port PT-RS), a maximum number of layers for codebook based transmission, a maximum number of layers for non-codebook based transmission, and the uplink full power mode(s). The UE may indicate these UE capabilities along with one of the followings: “non-coherent”, “partial and non-coherent”, “full and partial and non-coherent.”

In yet some other embodiments, the UE may report the UE assistance information indicating the preferred number of SRS ports and codebook coherency subset. The UE may transmit the UE assistance information via an RRC message or MAC CE. The network entity may then provide a configuration based on the received UE assistance information.

Alternative or additional to the above-described codebook coherency aspect, the NE and UE may determine the EPRE ratio between PT-RS and PUSCH based on the type of the indicated precoder, a number of scheduled layers for PUSCH, a number of PT-RS ports and/or a number of PUSCH ports. The type of the precoder indicates whether the UE is configured for coherent transmission, a partial coherent transmission or a non-coherent transmission and the number of non-zero power (NZP) ports for an N-port partial-coherent transmission.

In some implementations, the transmission power for each PT-RS resource element (RE) is the same as the transmission power for each PUSCH RE in each non-zero-power ports. The EPRE ratio

$${α}_{PTRS}^{PUSCH}$$

between the PT-RS and PUSCH can be as follows:

$${α}_{PTRS}^{PUSCH} = 10 {log}_{10} ( {M}_{v} ) \qquad ( 1 )$$

where Mᵥ indicates the number of layers corresponding to a non-zero-power antenna port for the indicated precoder or the type of the indicated precoder. In one example, Mᵥ indicates the number of non-zero coefficients in each row of the precoder. If the number of non-zero coefficients in each row of a precoder is different, My may indicate a maximum or a minimum number of non-zero coefficients in a row of the precoder.

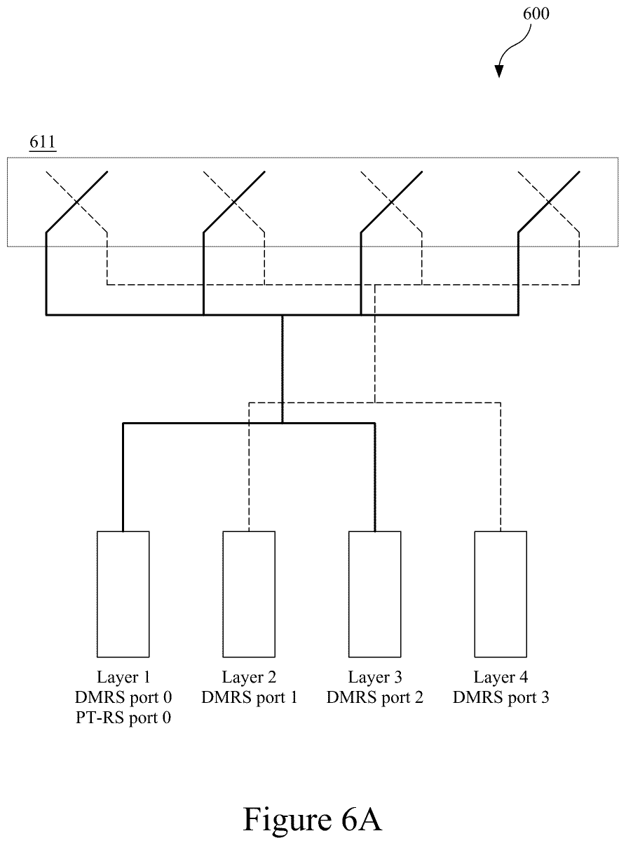

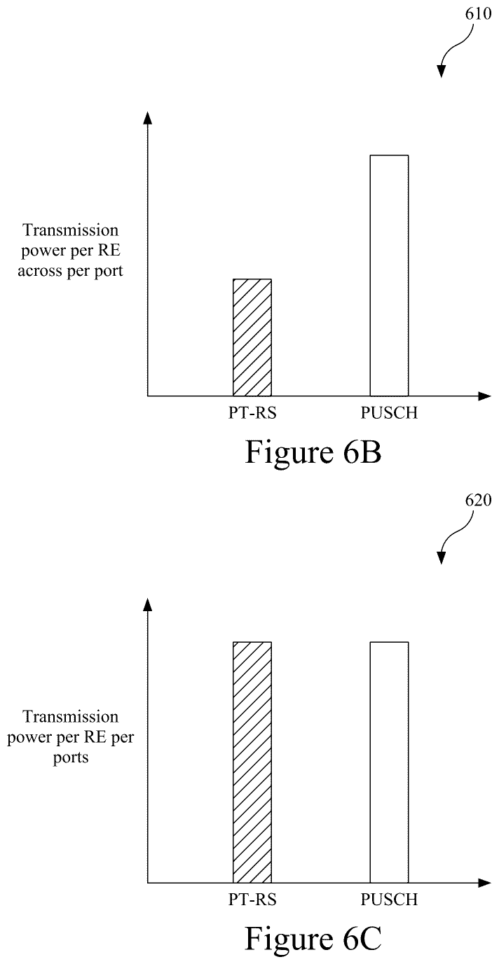

FIGS. 6A-6C illustrate EPRE ratio determination based on the number of layers corresponding to a non-zero-power antenna port according to an embodiment. In FIG. 6A, a subset of the UE's antenna ports 611 (i.e., the ones represented by continuous lines) are used for transmitting PT-RS, while the other ports (i.e., the ones represented by dashed lines) are otherwise used (e.g., for transmitting PUSCH data). In this scenario, a single PT-RS is transmitted using layer 1 (that is, PT-RS port 0 is associated with DMRS port 0), while layers 2-4 (DMRS ports 1-3) are used to simultaneously transmit other PUSCH data. FIG. 6B is a histogram 610 representing transmission power per resource element, RE, when power is conventionally allocated across ports. FIG. 6C is a histogram 620 representing transmission power per RE when power is allocated per ports resulting in a 3 dB PT-RS power boosting.

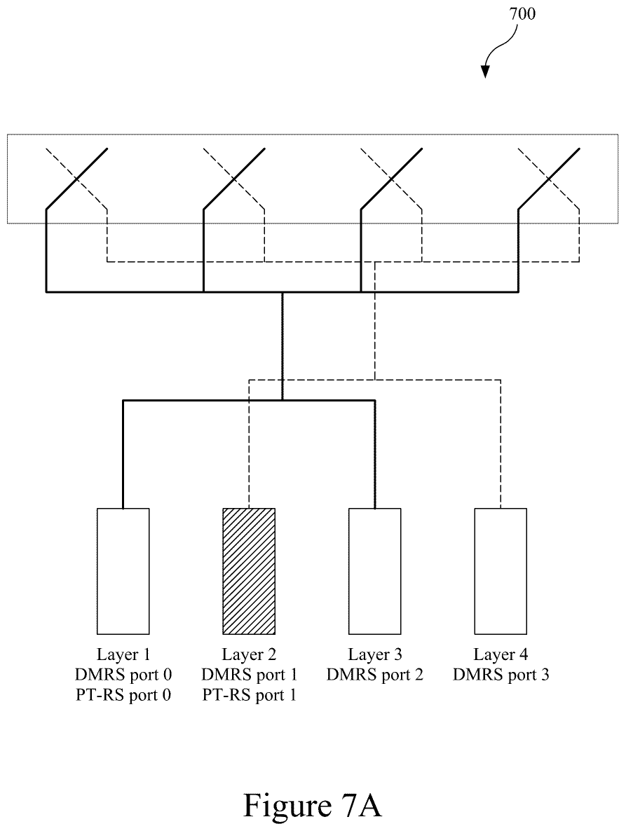

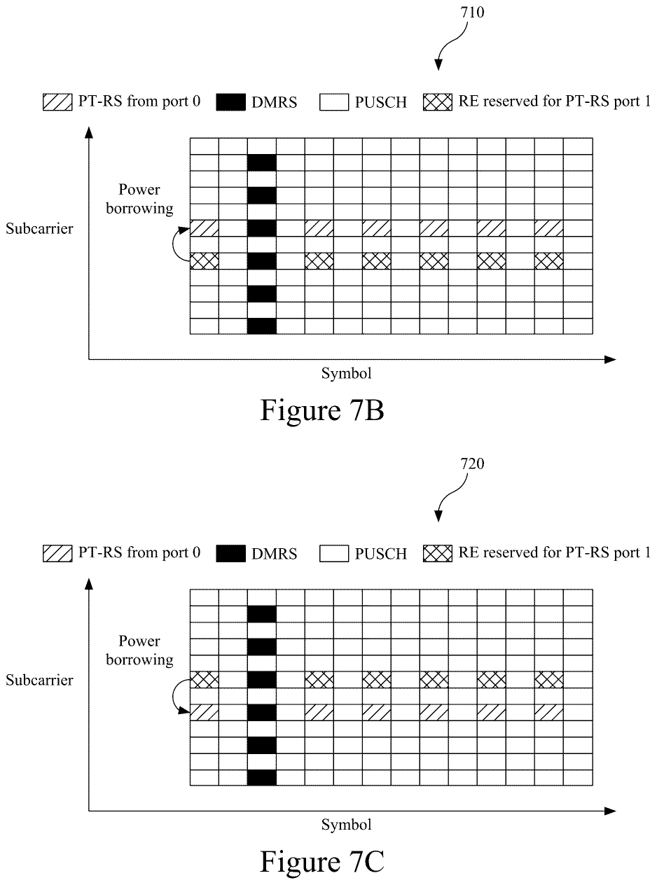

If plural PT-RS ports are configured, since the PT-RS ports are multiplexed in frequency division multiplexing (FDM) manner, the UE may be able to borrow power reserved for unused RE, thereby boosting PT-RS port(s) power level as illustrated in FIGS. 7A-7C. The UE may determine EPRE ratio between the PT-RS and PUSCH based also on the number of PT-RS ports as follows:

$${α}_{PTRS}^{PUSCH} = 10 {log}_{10} ( {Q}_{p} {M}_{v} ) \qquad ( 2 )$$

where Qₚ is the number of PT-RS ports.

FIG. 7A looks similar with FIG. 6A but here, a first subset of the UE's antenna ports 711 (i.e., the ones represented by continuous lines) are used for transmitting a first PT-RS, while the other ports (i.e., the ones represented by dashed lines) are used for transmitting a second PT-RS. In this scenario, the first PT-RS is transmitted using layer 1 (that is, PT-RS port 0 is associated with DMRS port 0), while the second PT-RS is transmitted using layer 2 (that is, PT-RS port 1 is associated with DMRS port 1). FIG. 7B illustrates a resource mapping pattern for transmissions using the subset of the UE's antenna ports 711 used for transmitting the first PT-RS, and FIG. 7C illustrates a resource mapping pattern for transmissions using a second subset of the UE's antenna ports 711, that is, the ones used for transmitting the second PT-RS.

In yet other embodiments, the maximum EPRE ratio may be smaller than or equal to an EPRE threshold due to a power limitation related to inter-carrier-interference (ICI) suppression. The EPRE threshold may be predefined (e.g., 9 dB) or reported by the UE capability, or configured by the NE via RRC signaling, a MAC CE or DCI. Thus, the UE can determine the EPRE ratio between the PT-RS and PUSCH as follows:

$${α}_{PTRS}^{PUSCH} = min ( 10 {log}_{10} ( {M}_{v} ) , T ) \qquad ( 3 )$$

$$or$$

$${α}_{PTRS}^{PUSCH} = min ( 10 {log}_{10} ( {Q}_{p} {M}_{v} ) , T ) \qquad ( 4 )$$

where T indicates the EPRE threshold.

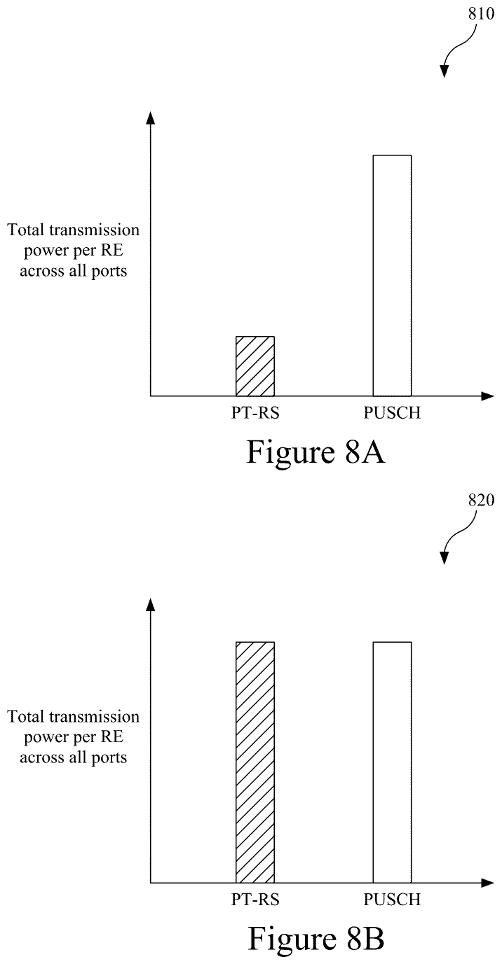

In some embodiments, the total transmission power for each PT-RS RE is the same as the total transmission power for each PUSCH RE across all transmission ports. Then the EPRE ratio between the PT-RS and PUSCH can be calculate as follows:

$${α}_{PTRS}^{PUSCH} = 10 {log}_{10} {N}_{L} \qquad ( 5 )$$

where N_{L} indicates the number of layers for the PUSCH transmission. The number of layers indicate the number of columns for the precoder applied for the PUSCH transmission. FIGS. 8A and 8B illustrates EPRE ratio determination for same configuration as illustrated in FIG. 6A but this EPRE ratio determination based on the number of layers for PUSCH. FIG. 8A is a histogram 810 illustrating power levels for PT-RS and PUSCH when power is conventionally allocated per RE across all ports. FIG. 8A is a histogram 810 illustrating power levels for PT-RS and PUSCH when PT-RS power level is boosted with 6 dB by determining the EPRE based on the number of layers.

If plural PT-RS ports are configured, since the PT-RS ports are multiplexed in FDM manner, the UE may be able to borrow the power for the unused RE for other PT-RS port(s). Then, the EPRE ratio between the PT-RS and PUSCH can be determined as follows:

$${α}_{PTRS}^{PUSCH} = 10 {log}_{10} ( {Q}_{p} {N}_{L} ) \qquad ( 6 )$$

where Qₚ is the number of PT-RS ports.

Some embodiments that take into consideration the ICI has EPRE ratio limited to an EPRE threshold (which may be predefined, reported via the UE capability, or configured by the NE). The EPRE ratio between the PT-RS and PUSCH is then:

$${α}_{PTRS}^{PUSCH} = min ( 10 {log}_{10} {N}_{L} , T ) \qquad ( 7 )$$

$$or$$

$${α}_{PTRS}^{PUSCH} = min ( 10 {log}_{10} ( {Q}_{p} {N}_{L} ) , T ) \qquad ( 8 )$$

where T is the EPRE ratio threshold.

In some embodiments, the NE may configure or indicate to the UE whether to transmit the PT-RS with the same transmission power for non-zero-power port(s) per resource element (RE) as the PUSCH, or to transmit the PT-RS with the same total transmission power across all the ports per RE as the PUSCH. The NE may provide the configuration or indication via RRC signaling, MAC CE or DCI.

The network entity may configure the EPRE ratio between the PT-RS and PUSCH for an 8-port PUSCH as summarized in following Table 2, Table 3 and Table 4, where the ICI-related upper bound for the EPRE ratio is 9 dB.

These tables illustrate an understanding between NE and UE regarding a double-bit indication (in first/leftmost column) included in the control signal and regarding the uplink PT-RS power level and the number of layers as well as the subset coherency type.

TABLE 2
EPRE ratio for an 8-port PUSCH transmission (1-4 layers)

| | | $The number of PUSCH layers ( {n}_{layer}^{PUSCH} )$ | | | | | | | |
|---|---|---|---|---|---|---|---|---|---|
| | | 2 | | 3 | | | | | |
| | | | 4-port and | | | 2-port | 4 | | |
| | | | 2-port | | | partial | | | 2-port |
| | | | Partial and | | | and | | | partial |
| UL- | | | non- | | | non- | | | and non- |
| PTRS- | | | coherent | | | coherent | | 4-port | coherent |
| power/ | 1 | | and non- | | | and non- | | and | and non- |
| ${α}_{PTRS}^{PUSCH}$ | All cases | Full coherent | codebook based | Full coherent | 4-port Partial | codebook based | Full coherent | partial coherent | codebook based |
| 00 | 0 | 3 | 3Qₚ − 3 | 4.77 | 3Qₚ or | 3Qₚ − 3 | 6 | 3Qₚ | 3Qₚ − 3 |
| | | | | | 3Qₚ − 3 | | | | |
| 01 | 0 | 3 | 3 | 4.77 | 4.77 | 4.77 | 6 | 6 | 6 |

| | |
|---|---|
| 10 | Reserved |
| 11 | Reserved |

TABLE 3
EPRE ratio for 8-port PUSCH transmission (5-6 layers)

| | $The number of PUSCH layers ( {n}_{layer}^{PUSCH} )$ | | | | | | | |
|---|---|---|---|---|---|---|---|---|
| | 5 | | | | | | | |
| UL- | | | | Non- | 6 | | | |
| PTRS- | | | | coherent | | 4-port | | Non-coherent |
| power/ | | 4-port | 2-port | and non- | | and | | and non- |
| ${α}_{PTRS}^{PUSCH}$ | Full coherent | Partial coherent | partial coherent | codebook based | Full coherent | partial coherent | 2-port partial coherent | codebook based |
| 00 | 6.99 | 3Qₚ or | 3Qₚ or | 3Qₚ − 3 | 7.78 | 3Qₚ or | 3Qₚ or 3Qₚ − 3 | 3Qₚ − 3 |
| | | 3Qₚ + 4.77 | 3Qₚ − 3 | | | 3Qₚ + 4.77 | | |
| 01 | 6.99 | 6.99 | 6.99 | 6.99 | 7.78 | 7.78 | 7.78 | 7.78 |

| | |
|---|---|
| 10 | Reserved |
| 11 | Reserved |

TABLE 4
EPRE ratio for an 8-port PUSCH transmission (7-8 layers)

| | $The number of PUSCH layers ( {n}_{layer}^{PUSCH} )$ | | | | | | | |
|---|---|---|---|---|---|---|---|---|
| | 7 | | | | | | | |
| UL- | | | | Non- | 8 | | | |
| PTRS- | | | | coherent | | 4-port | | Non-coherent |
| power/ | | 4-port | 2-port | and non- | | and | | and non- |
| ${α}_{PTRS}^{PUSCH}$ | Full coherent | Partial coherent | partial coherent | codebook based | Full coherent | partial coherent | 2-port partial coherent | codebook based |
| 00 | 8.45 | Min(3 | 3Qₚ or | 3Qₚ − 3 | 9 | Min(3Qₚ + | 3Qₚ or 3Qₚ − 3 | 3Qₚ − 3 |
| | | Qₚ or | 3Qₚ − 3 | | | 4.77 or | | |
| | | 3Qₚ + 4.77 | | | | 3Qₚ + 6, 9) | | |
| | | or | | | | | | |
| | | 3Qₚ + 6, 9) | | | | | | |
| 01 | 8.45 | 8.45 | 8.45 | 8.45 | 9 | 9 | 9 | 9 |

| | |
|---|---|
| 10 | Reserved |
| 11 | Reserved |

In some embodiments, the UE reports the UE capability indicating the supported configuration(s) and the EPRE ratio between PT-RS and PUSCH. For example, the UE may report whether it supports a common EPRE ratio between PT-RS and PUSCH for N-port partial coherent codebook and full coherent codebook or non-coherent codebook. The UE may report the UE capabilities based on the reported maximum number of SRS ports. Alternatively, the UE may report a list of the UE capabilities, where each UE capability corresponds to a number of configured ports. For example, for an 8-port UE, it may report the UE capability for 2-port, 4-port and 8-port respectively.

In some other embodiments, the UE reports the UE capability indicating a list of antenna port set(s) from which it can transmit the uplink signal with full power. The NE may then configure the UE to transmit the PT-RS with the same transmission power for non-zero-power port(s) per resource element (RE) as the PUSCH or to transmit the PT-RS with the same total transmission power across all the ports per RE as the PUSCH for precoders with certain set of non-zero-power ports. If the UE can support uplink transmission from a subset of antenna ports with PT-RS with full power, the UE can apply a 6 dB power boosting as shown figure in 8B, otherwise, the UE can apply a 3 dB power boosting for PT-RS as shown in FIG. 6C.

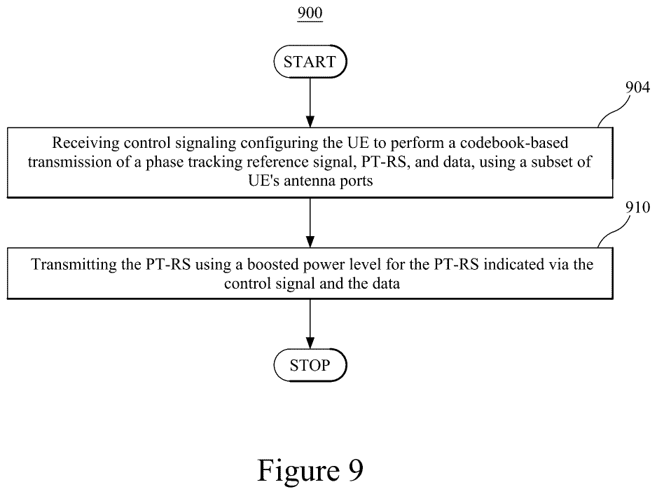

FIG. 9 is a flow diagram of a PT-RS power boosting method 900 performed by a UE (such as, UE 110). Method 900 includes receiving 902 control signaling configuring the UE to perform a codebook-based transmission of a phase tracking reference signal, PT-RS, and data, using a subset of UE's antenna ports. Method 900 further includes transmitting 910 the PT-RS using a boosted power level indicated via the control signal and the data. The data may be transmitted on PUSCH.

Method 900 may further include increasing a PT-RS power available to at least one antenna port to be used for transmitting the PT-RS to be equal to a data-transmission power available to an antenna port to be used to transmit the data. Alternatively, method 900 may include obtaining a ratio between the boosted power level and a power level usable by an antenna port to transmit the data, according to a first indication included in the control signaling. The UE may obtain the ratio based on a number of transmission layers corresponding to non-zero coefficients in a row of a precoder used by the UE for the codebook-based transmission using the subset of antenna ports. Alternatively, the UE may obtain the ratio using a number of antenna ports configured for transmitting the data. If plural antenna ports in the subset are usable to transmit the PT-RS, the UE may obtain the ratio taking into consideration the number of PT-RS antenna ports. Additionally, the UE may limit the ratio to less than or equal to a predefined threshold value related to inter-carrier-interference. UE's obtaining the ratio may include identifying a value of the ratio from predefined values depending on a number of antenna ports in the subset and/or a codebook coherency type of the subset.

Method 900 may further include transmitting an indication corresponding to one or more codebook coherency types supported by the UE for the codebook-based transmission. The control signaling may then include a subset-codebook-coherency type compatible to the one or more indicated codebook coherency types. The indication identifies the UE being able to transmit a non-coherent transmission, a partial coherent transmission, or a fully coherent transmission, the subset-codebook-coherency type may be different from the one or more codebook coherency types.

The control signaling may be received via an RRC message that includes a subset coherency type associated with a number of the UE's antenna ports in the subset.

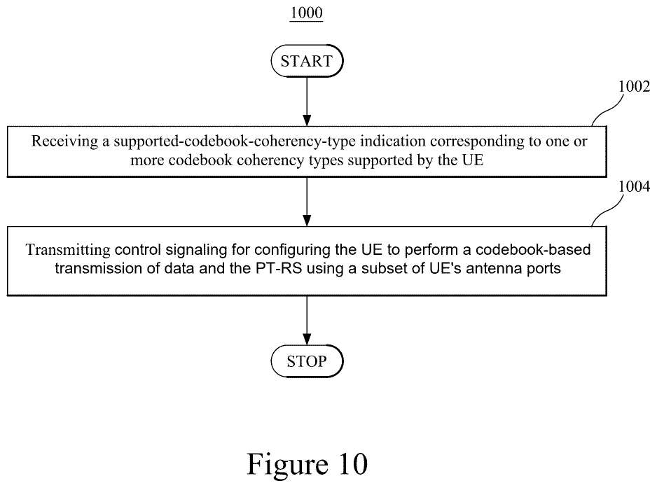

FIG. 10 illustrates a flowchart of a method 1000 performed by an NE (such as, NE 120) according to an embodiment. Method 1000 includes receiving 1002 a supported-codebook-coherency-type indication corresponding to one or more codebook coherency types supported by the UE. Method 1000 further includes transmitting 1004 control signaling for configuring the UE to perform a codebook-based transmission of data and the PT-RS simultaneously, using a subset of UE's antenna ports. Here, the control signaling indicates a subset-codebook-coherency type associated with a number of the UE's antenna ports in the subset, the subset-codebook-coherency type being compatible with UE-supported codebook coherency types.

Method 1000 may further include receiving a message conveying UE's capability to boost a power level of the PT-RS. Here, the control signaling further includes a power-boosting-related indication directing the UE to transmit the PT-RS with a boosted power level, the boosted power level being determined according to a technique within the UE's capability.

The embodiment descriptions in this section refer to the accompanying drawings. The same reference numbers in different drawings identify the same or similar elements. The detailed descriptions do preclude other embodiments within the scope of the appended claims. The embodiments are not limited to the described configurations but may be extended to other arrangements.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A method performed by a user equipment (UE) the method comprising:
transmitting an indication corresponding to one or more codebook coherency types supported by the UE for a codebook-based transmission;
receiving control signaling including a subset-codebook-coherency type compatible with the indication, the control signaling configuring the UE to perform the codebook-based transmission of data and transmission of a phase tracking reference signal (PT-RS) using a subset of UE's antenna ports; and
transmitting the PT-RS using a power level indicated via the control signaling and the data.

19. The method of any of claim 18, further comprising:
increasing a PT-RS power available to a first antenna port to be used for transmitting the PT-RS to be equal to a data-transmission power available to a second antenna port to be used for transmitting the data.

20. The method of claim 18, wherein the data is transmitted on a physical uplink shared channel (PUSCH) and the power level is an energy per resource element (EPRE).

21. The method of claim 20, further comprising:
obtaining an EPRE ratio between the PT-RS and the PUSCH.

22. The method of claim 21, wherein the obtaining the EPRE ratio is based on a number of transmission layers for the PUSCH.

23. The method of claim 21, wherein the obtaining the EPRE ratio is based on a number of antenna ports configured for transmitting the PUSCH.

24. The method of claim 21, wherein, if plural antenna ports in the subset are usable to transmit the PT-RS, the obtaining the EPRE ratio is further based on a number of the plural antenna in addition to a number of transmission layers for the PUSCH or a number of antenna ports configured for transmitting the PUSCH.

25. The method of claim 21, wherein the obtaining the EPRE ratio further includes limiting the EPRE ratio to be less than or equal to a predefined threshold value.

26. The method of claim 21, wherein the obtaining the EPRE ratio includes identifying a value of the EPRE ratio from predefined values depending on at least one of a number of antenna ports in the subset or a codebook coherency type of the subset.

27. The method of claim 18, wherein the indication specifies the UE supports one or more of a non-coherent transmission, a partial coherent transmission, or a fully coherent transmission.

28. The method of claim 27, wherein the subset-codebook-coherency type indicates a different-coherency uplink transmission than UE supported transmissions according to the indication.

29. The method of claim 18, wherein the receiving the control signaling includes receiving a radio resource control message that conveys the subset-codebook coherency type associated with a number of the UE's antenna ports in the subset.

30. The method of claim 18, wherein the receiving the control signaling includes receiving a downlink control information message that conveys an uplink grant for the codebook-based transmission and indicates one of the one or more codebook coherency types as the subset-codebook-coherency type.

31. A user equipment (UE) comprising:
a transceiver; and
a processor coupled to the transceiver and configured to:
transmit an indication corresponding to one or more codebook coherency types supported by the UE for a codebook-based transmission,
receive control signaling including a subset-codebook-coherency type compatible with the indication, the control signaling configuring the UE to perform the codebook-based transmission of data and transmission of a phase tracking reference signal (PT-RS) using a subset of UE's antenna ports, and
transmit the PT-RS using a power level indicated via the control signaling and the data.

32. The UE of claim 31, wherein the processor is further configured to increase a PT-RS power available to a first antenna port to be used for transmitting the PT-RS to be equal to a data-transmission power available to a second antenna port to be used for transmitting the data.

33. The UE of claim 31, wherein the data is transmitted on a physical uplink shared channel (PUSCH) and the processor is further configured to:
obtain an energy per resource element (EPRE) ratio between the PT-RS and the PUSCH based on a number of transmission layers for the PUSCH or a number of antenna ports configured for transmitting the PUSCH.

34. The UE of claim 33, wherein the processor is further configured to limit the EPRE ratio to be less than or equal to a predefined threshold value.

35. A method performed by a network entity (NE), the method comprising:
receiving a supported-codebook-coherency-type indication corresponding to one or more codebook coherency types supported by a user equipment (UE); and
transmitting control signaling for configuring the UE to perform a codebook-based transmission of data and a transmission of a phase tracking reference signal (PT-RS), using a subset of UE's antenna ports, the control signaling indicating a subset-codebook-coherency type associated with a number of the UE's antenna ports in the subset, the subset-codebook-coherency type being compatible with the one or more codebook coherency types.

36. The method of claim 35, further comprising:
receiving a message conveying UE's capability to boost a power level of the PT-RS, wherein the control signaling further includes a power-boosting-related indication directing the UE to transmit the PT-RS with a boosted power level, the boosted power level being determined according to a technique within the UE's capability.

37. A wireless communication device comprising:
a transceiver; and
a processor coupled to the transceiver and configured to:
receive a supported-codebook-coherency-type indication corresponding to one or more codebook coherency types supported by a user equipment (UE); and
transmit control signaling for configuring the UE to perform a codebook-based transmission of data and a transmission of a phase tracking reference signal (PT-RS), using a subset of UE's antenna ports, the control signaling indicating a subset-codebook-coherency type associated with a number of the UE's antenna ports in the subset, the subset-codebook-coherency type being compatible with the one or more codebook coherency types.
